(19) United States
(12) Patent Application Publication
(10) Pub. No.: US 2025/0023022 A1
(43) Pub. Date: Jan. 16, 2025

(54) ANODE FOR SECONDARY BATTERY AND LITHIUM SECONDARY BATTERY INCLUDING THE SAME

(71) Applicant: SK ON CO., LTD., Seoul (KR)

(72) Inventors: So Hyun PARK, Daejeon (KR); Jae Ram KIM, Daejeon (KR); Jeong Seok YEON, Daejeon (KR); Ji Won NA, Daejeon (KR); Sang Won BAE, Daejeon (KR); Ji Hee BAE, Daejeon (KR); Jae Yeong LEE, Daejeon (KR)

(21) Appl. No.: 18/751,341

(22) Filed: Jun. 24, 2024

(30) Foreign Application Priority Data
Jul. 11, 2023 (KR) 10-2023-0089762

(51) Int. Cl. H01M 4/36; H01M 4/02; H01M 4/133; H01M 4/48; H01M 4/587; H01M 10/052

(52) U.S. Cl. CPC H01M 4/366; H01M 4/133; H01M 4/48; H01M 4/587; H01M 10/052; H01M 2004/021; H01M 2004/027

(57) ABSTRACT

An anode for a lithium secondary battery includes an anode current collector, and an anode active material layer formed on at least one surface of the anode current collector. The anode active material layer includes a first region adjacent to the anode current collector and a second region spaced apart from the anode current collector in a thickness direction with the first region interposed therebetween. The anode active material layer includes an anode active material including an artificial graphite-based active material and a silicon-based active material having a minimum particle diameter (Dₘᵢₙ) in a range from 1 μm to 5 μm. A content of the silicon-based active material based on a total weight of the anode active material included in the second region is greater than a content of the silicon-based active material based on a total weight of the anode active material included in the first region.

### CROSS-REFERENCE TO RELATED APPLICATION AND CLAIM OF PRIORITY

This application claims priority to Korean Patent Application No. 10-2023-0089762 filed on Jul. 11, 2023 in the Korean Intellectual Property Office (KIPO), the entire disclosure of which is incorporated by reference herein.

### BACKGROUND

### 1. Field

The disclosure of the present application relates to an anode for a secondary battery and a lithium secondary battery including the same.

### 2. Description of the Related Art

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as a power source of an eco-friendly vehicle such as an electric automobile.

Examples of the secondary battery includes a lithium secondary battery, a nickel-cadmium battery, a nickel-hydrogen battery, etc. The lithium secondary battery is being actively developed and applied due to high operational voltage and energy density per unit weight, a high charging rate, a compact dimension, etc.

For example, the lithium secondary battery may include an electrode assembly including a cathode, an anode and a separation layer (separator), and an electrolyte immersing the electrode assembly. The lithium secondary battery may further include an outer case having, e.g., a pouch shape accommodating the electrode assembly and the electrolyte.

Recently, as an application range of the lithium secondary battery has been expanded, developments of a lithium secondary battery having higher capacity and power is being progressed. For example, a silicon-based active material and a carbon-based active material may be used together as an anode active material.

### SUMMARY

According to an aspect of the present invention, there is provided an anode for a secondary battery having improved electrochemical property and mechanical stability.

According to an aspect of the present invention, there is provided a lithium secondary battery having improved electrochemical property and mechanical stability.

An anode for a lithium secondary battery includes an anode current collector, and an anode active material layer formed on at least one surface of the anode current collector. The anode active material layer includes a first region adjacent to the anode current collector and a second region spaced apart from the anode current collector in a thickness direction with the first region interposed therebetween. The anode active material layer includes an anode active material including an artificial graphite-based active material and a silicon-based active material having a minimum particle diameter (Dₘᵢₙ) in a range from 1 μm to 5 μm. A content of the silicon-based active material based on a total weight of the anode active material included in the second region is greater than a content of the silicon-based active material based on a total weight of the anode active material included in the first region.

In some embodiments, the silicon-based active material may have the minimum particle diameter (Dₘᵢₙ) in a range from 2 μm to 4 μm.

In some embodiments, the silicon-based active material may include a silicon-based oxide containing at least one doping element selected from Mg, Li, N, B, P, Al, Cu, Mn, Ca and Zn.

In some embodiments, a volumetric average particle diameter (D50) of the silicon-based active material may be greater than 6 μm, and less than or equal to 10 μm.

In some embodiments, a ratio D90/D10 may be in a range from 1.5 to 2.5, D10 corresponds 10% in a cumulative particle size distribution based on a volume of the silicon-based active material, and D90 corresponds to 90% in the cumulative particle size distribution based on the volume of the silicon-based active material.

In some embodiments, the content of the silicon-based active material based on the total weight of the anode active material included in the first region may be 1 wt % or more, and less than 10 wt %. The content of the silicon-based active material based on the total weight of the anode active material included in the second region may be in a range from 10 wt % to 25 wt %.

In some embodiments, the artificial graphite-based active material may include a first graphite having a single particle structure and a second graphite having a secondary particle structure.

In some embodiments, a content of the first graphite based on the total weight of the anode active material included in the second region may be greater than a content of the first graphite based on the total weight of the anode active material included in the first region. A content of the second graphite based on the total weight of the anode active material included in the second region may be smaller than a content of the second graphite based on the total weight of the anode active material included in the first region.

In some embodiments, the first graphite may include a graphite of the single particle structure including an amorphous carbon coating on a particle surface.

In some embodiments, a thickness of the first region may be in a range from 30% to 70% of a total thickness of the anode active material layer, and a thickness of the second region may be in a range from 30% to 70% of the total thickness of the anode active material layer.

In some embodiments, an interface region may exist between the first region and the second region. A content of the silicon-based active material based on a total weight of the anode active material included in the interface region is equal to or greater than the content of the silicon-based active material based on the total weight of the anode active material included in the first region, and is equal to or less than the content of the silicon-based active material based on the total weight of the anode active material included in the second region.

In some embodiments, the anode active material layer may include pores, and a pore amount in the anode active material layer measured using a mercury porosimeter may be in a range from 0.165 ml/g to 0.25 ml/g.

In some embodiments, the anode active material layer may include pores, and an average pore diameter of the anode active material layer measured using a mercury porosimeter may be in a range from 500 nm to 1,000 nm.

In some embodiments, the anode active material layer may include pores, and the anode active material layer may have a pore diffusion resistance of 8 Ω or less.

A lithium secondary battery includes the above-described anode for a secondary battery, a cathode facing the anode and an electrolyte solution.

An anode according to embodiments of the present disclosure may include an anode active material layer including a higher content of a silicon-based active material in an upper portion (a second region) than that in a lower portion (a first region). Accordingly, a volume of the anode may not expand excessively when repeatedly charging and discharging a battery, and life-span properties of the battery may be improved.

The anode according to embodiments of the present disclosure may include a silicon-based active material having a minimum particle diameter of 1 μm to 5 μm, and pores may be achieved between silicon-based active material particles. Accordingly, a pore diffusion resistance in the anode active material layer may be lowered, and a diffusion rate of lithium ions may be increased, thereby improving a rapid charging performance of the battery.

In some embodiments, the silicon-based active material may include a silicon-based oxide containing a doping element. Accordingly, a crystal structure of the silicon-based oxide may be stabilized so that an initial charge/discharge efficiency of the battery may be improved.

### BRIEF DESCRIPTION OF THE DRAWINGS

FIG. 1 is a schematic cross-sectional view illustrating an anode for a secondary battery in accordance with example embodiments.

FIG. 2 is a schematic plan-projection view illustrating a lithium secondary battery in accordance with example embodiments.

FIG. 3 is a schematic cross-sectional view illustrating a lithium secondary battery in accordance with example embodiments.

### DETAILED DESCRIPTION OF THE EMBODIMENTS

According to embodiments of the present disclosure, an anode for a secondary battery including a silicon-based active material in an anode active material layer and a lithium secondary battery including the anode are provided. The anode for a secondary battery may be introduced so that an electrode detachment of electrodes may be prevented, a cell performance can be improved, and a secondary having high energy density may be implemented.

A minimum particle diameter (Dₘᵢₙ) and a maximum particle diameter (Dₘₐₓ) may be measured using a scanning electron microscope (SEM), a transmission electron microscope (TEM), or a light scattering method. The term “particle diameter” as used herein may refer to the longest diameter of any particle. For example, the minimum particle diameter (Dₘᵢₙ) may refer to the smallest particle diameter measured using a laser diffraction particle size analyzer after a silicon-based active material is dispersed in a dispersion medium.

The minimum particle diameter (Dₘᵢₙ) may be determined based on a fitting curve of a volume-based particle size distribution of the silicon-based active material particles. For example, even when some particles having a particle diameter (D′) smaller than the minimum particle diameter (Dmin) identified in the fitting curve graph of the volume-based particle size distribution of the silicon-based active material particles are included, D′ does not affect the determination of the minimum particle diameter (Dₘᵢₙ).

An average particle diameter (D50) refers to a particle diameter corresponding to 50% of a volume fraction in a cumulative volume-based particle size distribution determined by a laser diffraction particle size distribution measurement. D10 and D90 refer to particle diameters corresponding to a point having a volume fraction of 10% and 90%, respectively, in the cumulative volume-based particle size distribution.

Hereinafter, embodiments of the present disclosure will be described in detail. However, those skilled in the art will appreciate that such embodiments are provided to further understand the spirit of the present inventive concepts do not limit the subject matters to be protected as disclosed in the detailed description and appended claims.

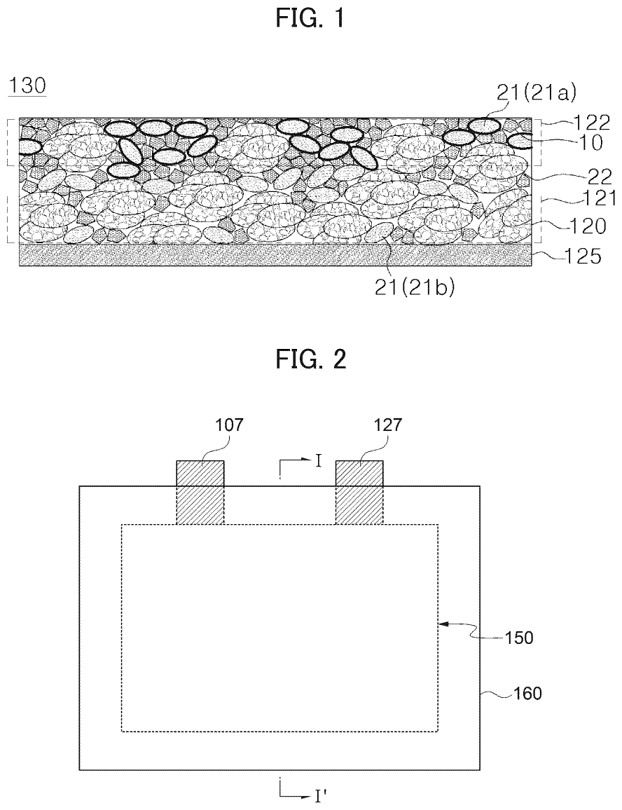

FIG. 1 is a schematic cross-sectional view illustrating an anode for a secondary battery in accordance with example embodiments.

Referring to FIG. 1, an anode 130 for a secondary battery may include an anode active material layer 120 formed on a surface of an anode current collector 125. The anode active material layer 120 may be formed on one surface (e.g., upper surface) or both surfaces (e.g., upper and lower surface) of the anode current collector 125.

In example embodiments, the anode active material layer 120 may include an anode active material. The anode active material may include a silicon-based active material 10 and artificial graphite-based active materials 21 and 22. The silicon-based active material may be used to increase a capacity of the anode, and the graphite-based active material may be used to enhance stability of the anode.

The silicon-based active material may refer to a silicon-containing active material that may not include a graphite. In example embodiments, the silicon-based active material 10 may include silicon, a silicon alloy, a silicon oxide represented by SiOx (0<x<2), a silicon-based oxide including a doped metal, a silicon carbide (Si-C), a particles having a silicon-containing core-shell structure. These may be used alone or in a combination thereof.

In example embodiments, the silicon-based active material 10 may include a silicon-based oxide including at least one doping element of Mg, Li, N, B, P, Al, Cu, Mn, Ca and Zn. In some embodiments, the silicon-based active material 10 may include a silicon-based oxide containing Mg as a doping element. The silicon-based oxide may be represented by SiOx (0<x<2), and the doped element may be doped in a form that is substituted at a Si site of the silicon-based oxide. The silicon-based oxide including the doped element may be prepared by a vapor deposition of a metal such as Mg, Li, etc., in a preparation of SiOx (0<x<2).

The silicon-based active material 10 may include the silicon-based oxide including the doping element in an amount of 50 weight percent (wt %) or more, 60 wt % or more, 70 wt % or more, 80 wt % or more, or 90 wt % or more based on a total weight of the silicon-based active material 10. In some embodiments, the silicon-based active material 10 may substantially consist of the silicon-based oxide including the doping element.

A crystal structure of the anode active material may be stabilized during an initial charging and discharging of the anode by the silicon-based oxide containing the doping metal, thereby improving initial efficiency propertied of a battery.

In example embodiments, the silicon-based active material 10 may have a minimum particle diameter Dₘᵢₙ in a range from 1 μm to 5 μm. In some embodiments, the silicon-based active material 10 may have a minimum particle diameter Dₘᵢₙ in a range from 2 μm to 4 μm, from 2.1 to 2.8 μm, or from 2.2 to 2.5 μm. In the above range, a relatively large pore may be formed between particles of the silicon-based active material 10, and an electrolyte may penetrate into the pore. Accordingly, a pore diffusion resistance may be lowered, and rapid charge life-span properties of the anode may be improved.

If the minimum particle diameter Dₘᵢₙ of the silicon-based active material 10 is less than 1 μm, pores in the anode active material layer may not be sufficiently formed, and an anode density may be excessively increased to be disadvantageous in a lithium ion diffusion. If the minimum particle diameter Dₘᵢₙ of the silicon-based active material 10 is greater than 5 μm, volume expansion and contraction of the electrode may excessively occur due to charging and discharging of the battery to degrade the stability of the battery.

In addition, the silicon-based active material having a relatively high hardness may be large, and thus damage may occur to the cathode current collector.

In example embodiments, an average particle diameter D50 of the silicon-based active material 10 may be greater than 6 μm, and less than or equal to 10 μm. In some embodiments, the average particle diameter D50 of the silicon-based active material 10 may be in a range from 6.1 μm to 9 μm, from 6.2 μm to 7 μm, or from 6.3 μm to 6.8 μm. In the above range, pores between the particles may be sufficiently formed while obtaining a surface area of the particles of the silicon-based active material 10.

In example embodiments, the silicon-based active material 10 may have a D10 in a range from 3.5 μm to 6 μm. In some embodiments, the silicon-based active material 10 may have the D10 in a range from 4 μm to 5 μm.

In example embodiments, the silicon-based active material 10 may have a D90 in a range from 9 μm to 15 μm. In some embodiments, the silicon-based active material 10 may have the D90 in a range from 10 μm to 13 μm.

According to embodiments, D90/D10 of the silicon-based active material 10 may be less than or equal to 2.5. In some embodiments, D90/D10 of the silicon-based active material 10 may be in a range from 1.5 to 2.5, or from 2.3 to 2.49. In the above range, the particle size distribution of the silicon-based active material 10 may become more uniform, and a volume of the entire anode may be changed more uniformly even when the volume of the anode is expanded, thereby improving electrode life-span properties.

In some embodiments, the silicon-based active material 10 may have a maximum particle diameter Dₘₐₓ of greater than 15 μm, and less than or equal to 30 μm. In some embodiments, the maximum particle diameter Dₘₐₓ of the silicon-based active material 10 may be greater than or equal to 15 μm, and less than or equal to 20 μm.

The anode active material layer 120 may include a first region 121 and a second region 122. The first region 121 may be a partial region of the anode active material layer 120 adjacent to the anode current collector 125. The second region 122 may be a partial region of the anode active material layer 120 spaced apart from the anode current collector in a thickness direction.

The first region 121 may contain a high content of an active material having a relatively low hardness. Accordingly, the first region 121 may have a higher density, a smaller porosity and a higher volumetric stability during battery charging and discharging than those of the second region 122.

The second region 122 may contain a high content of an active material having a relatively high hardness. Accordingly, the second region 122 has a lower density and a higher porosity than those of the first region 121 to protect the anode current collector 125 during the anode manufacturing process.

The first region 121 and the second region 122 may include the silicon-based active material 10 and the artificial graphite-based active materials 21 and 22. A content of the silicon-based active material based on a total weight of the anode active material in the second region 122 may be greater than a content of the silicon-based active material based on a total weight of the anode active material in the first region 121.

Generally, the silicon-based active material has a higher hardness than that of the artificial graphite-based active material, and has a high expansion and contraction ratio when the battery is repeatedly charged and discharged. In consideration of the properties of the silicon-based active material, the content of the silicon-based active material 10 in the second region 122 directly subjected to a pressure during coating, drying and pressing of a slurry may be adjusted to be larger than the content of the silicon-based active material 10 in the first region 121.

The content of the silicon-based active material 10 in the first region 121 adjacent to the anode current collector 125 may be smaller, so that volume expansion of the anode active material layer 120 in the first region 121 may be controlled during charging and discharging of the battery, thereby improving the electrode stability. Further, the anode active material layer 120 in the second region 122 spaced apart from the anode current collector 125 may have a greater amount of pores than that in the first region 121, so that a buffer space may be achieved during an expansion of the silicon-based active material 10. Additionally, the content of the high-hardness silicon-based active material 10 in the second region 122 directly receiving the pressure in the pressing process during the anode fabrication process may be increased, so that damages to the anode current collector 125 may be prevented.

In example embodiments, the content of the silicon-based active material 10 based on the total weight of the anode active material in the first region 121 may be 1 wt % or more, and less than 10 wt %, and the content of the silicon-based active material 10 based on the total weight of the anode active material in the second region 122 may be in a range from 10 wt % to 25 wt %.

In some embodiments, the content of the silicon-based active material 10 based on the total weight of the anode active material in the first region 121 may be in a range from 2 wt % to 7 wt %, and the content of the silicon-based active material 10 based on the total weight of the anode active material in the second region 122 may be in a range from 15 wt % to 20 wt %. In the above range, structural stability during charging and discharging may be enhanced while increasing the capacity of the anode.

In example embodiments, the artificial graphite-based active materials 21 and 22 may include a first graphite 21 having a single particle structure and a second graphite 22 having a secondary particle structure. The term “secondary particle structure” may refer an assembled particle formed by an aggregation of primary particles. For example, the secondary particle includes a plurality of primary particles, and a boundary of the primary particles may be observed in an SEM cross-sectional image. For example, the secondary particle may include more than 10, 30 or more, 50 or more, or 100 or more primary particles aggregated therein.

The term “single particle structure” as used herein is intended to exclude a secondary particle formed by an agglomeration or an aggregation of a plurality of primary particles. For example, the first graphite 21 may substantially consist of single particle-type particles, and a secondary particle structure in which the primary particles are assembled or aggregated may be excluded.

The term “single particle structure” does not exclude a monolith structure including, e.g., 2 to 10 single particles being attached or closely adjacent to each other.

In example embodiments, the first graphite 21 may include a coated single particle artificial graphite 21a including an amorphous carbon coating on a particle surface. In some embodiments, the first graphite 21 may include the coated single-particle artificial graphite 21a and an uncoated single-particle artificial graphite 21b that does not include the amorphous carbon coating on a particle surface. The coated single particle artificial graphite 21a may have higher hardness and stability than those of the uncoated single particle artificial graphite 21b due to the carbon coating layer on the surface, and may improve the stability of the anode.

In example embodiments, the first graphite 21 included in the first region 121 may be the uncoated single particle artificial graphite 21b, and the first graphite 21 included in the second region 122 may be the coated single particle.

The second region 122 may be spaced apart from the anode current collector 125 and may be in contact with an electrolyte solution in advance to the first region 121 within an inside of the battery. Thus, when the anode is impregnated in the electrolyte solution, the electrolyte solution may pass through the second region 122 in advance, and then may be propagated to the first region 121.

Accordingly, an amount of the pores in the second region 122 may be larger than that in the first region 121 to improve rapid charge properties of the battery. Further, the first region 121 may have a smaller pore volume than that of the second region 121, but may have a higher density. Thus, an energy density of the battery may be improved, and a high-capacity secondary battery may be implemented.

The second region 122 may include the coated single particle artificial graphite 21a having a higher hardness, so that the particles may not be pressed during a pressing process in the fabrication of the anode to sufficiently achieve the pores between the first graphite particles in the second region 122.

The first region 121 includes the uncoated single particle artificial graphite 21b having a relatively low hardness, and the particles may be pressed during the pressing process in the fabrication of the anode. Thus, the density of the first region 121 may be increased, so that the capacity and the energy density of the anode may be increased.

In example embodiments, a content of the artificial graphite-based active material based on the total weight of the anode active material in the first region 121 may be greater than a content of the artificial graphite-based active material based on the total weight of the anode active material in the second region 122.

In example embodiments, a content of the first graphite 21 based on the total weight of the anode active material in the first region 121 may be smaller than a content of the first graphite 21 based on the total weight of the anode active material in the second region 122. A content of the second graphite 22 based on the total weight of the anode active material in the first region 121 may be greater than a content of the second graphite 22 based on the total weight of the anode active material in the second region 122.

In example embodiments, the content of the first graphite 21 based on the total weight of the anode active material in the first region 121 may be less than the content of the second graphite 22 based on the total weight of the anode active material in the first region 121. Accordingly, the content of the second graphite 22 having the secondary particle (assembly) structure may be relatively large in the first region 121. The artificial graphite having the secondary particle structure has a relatively low hardness compared to that of the single particle structure, and thus the hardness of the first region 121 may be lowered, thereby providing a high energy density.

In example embodiments, a content of the first graphite 21 based on a total weight of the artificial graphite-based active material in the first region 121 may be in a range from 10 wt % to 40 wt %, and a content of the second graphite 22 based the total weight of the artificial graphite-based active material in the first region 121 may be in a range from 60 wt % to 90 wt %.

In example embodiments, the content of the first graphite 21 based on the total weight of the anode active material in the second region 122 may be greater than the content of the second graphite 22 based on the total weight of the anode active material in the second region 122. Accordingly, the content of the first graphite 21 having the single-particle structure may be relatively large in the second region 122. The artificial graphite having the single-particle structure has a relatively high hardness compared to that of the secondary particle structure, and the hardness of the second region 122 may be increased. Thus, the second region 122 may provide more pores than those in the first region 121, thereby improving the rapid charging properties of the battery.

In example embodiments, a content of the first graphite 21 based on a total weight of the artificial graphite-based active material in the second region 122 may be in a range from 60 wt % to 90 wt %, and a content of the second graphite 22 based on the total weight of the artificial graphite-based active material in the second region 122 may be in a range from 10 wt % to 40 wt %.

In example embodiments, a thickness of the anode active material layer 120 is not particularly limited, and may be, for example, in a range from 10 μm to 300 μm.

In example embodiments, a thickness of the first region 121 may be in a range from 30% to 70% of a total thickness of the anode active material layer 120, and a thickness of the second region 122 may be in a range from 30% to 70% of the total thickness of the anode active material layer 122. For example, the thickness of the first region 121 may be about 40% of the total thickness of the anode active material layer 120, and the thickness of the second region 122 may be about 40% of the total thickness of the anode active material layer 120.

In example embodiments, an interface region may exist between the first region 121 and the second region 122. The anode 130 may be prepared by coating a slurry for forming the anode active material layer on the anode current collector 125, and then drying and pressing the slurry.

In some embodiments, while commonly coating a slurry for forming the first region and a slurry for forming the second region, the slurry for forming the first region may be sprayed to be adjacent to the current collector, and the slurry for forming the second region may be sprayed on the slurry for forming the first region. The slurry for forming the first region and the slurry for forming the second region in the composition states may be mixed at an interface to form the interface region.

A content of the silicon-based active material based on the total weight of the anode active material in the interface region may be greater than or equal to the content of the silicon-based active material based on the total weight of the anode active material in the first region, and may be less than or equal to the content of the silicon-based active material based on the total weight of the anode active material in the second region.

A content of the graphite-based active material based on the total weight of the anode active material in the interface region may be greater than or equal to the content of the graphite-based active material based on the total weight of the anode active material in the second region, and may be less than or equal to the content of the graphite-based active material based on the total weight of the anode active material in the first region.

In example embodiments, the anode active material may further include a different active material from to the artificial graphite-based active material and the silicon-based active material. For example, the anode active material may further include natural graphite, artificial graphite, a graphitized coke, a graphitized mesocarbon microbead, a graphitized mesophase pitch-based carbon fiber, etc.

In example embodiments, the anode active material layer 120 may further include an anode binder and a conductive material.

For example, the anode active material layer 120 can be prepared by mixing and stirring the silicon-based active material, the artificial graphite-based active material, the anode binder, the conductive material, a dispersion medium, etc., to prepare the slurry for forming the first region and the slurry for forming the second region.

The slurry for forming the first region and the slurry for forming the second region may be coated together on the anode current collector 125, and them dried and pressed. The slurry for forming the first region may be sprayed to be adjacent to the current collector, and the slurry for forming the second region may be sprayed on the sprayed slurry for forming the first region.

In example embodiments, when forming the anode active material layer on both surfaces of the anode current collector, the anode active material layer may be formed on each of one surface and the other surface of the anode current collector 125 by the above-describe method.

For example, the anode current collector 125 may include gold, stainless steel, nickel, aluminum, titanium, copper, or an alloy thereof, and may preferably include copper or a copper alloy.

For example, the binder may include an organic binder such as polyvinylidene fluoride (PVDF), a vinylidene fluoride-hexafluoropropylene copolymer (PVDF-co-HFP), polyacrylonitrile, polymethyl methacrylate, etc., or an aqueous binder such as styrene-butadiene rubber (SBR) that may be used with a thickener such as carboxymethyl cellulose (CMC).

For example, the conductive material may include a carbon-based conductive material such as graphite, carbon black, graphene, carbon nanotube, etc.; a metal-based conductive material such tin, tin oxide, titanium oxide, a perovskite material including, e.g., LaSrCoO3, LaSrMnO3, etc.

In example embodiments, the anode active material layer 120 may include pores as voids between the anode active material particles.

In example embodiments, a pore amount of the anode active material layer may be in a range from 0.165 ml/g to 0.25 ml/g. The pore amount may be measured using a mercury porosity meter, and may represent a volume of pores per unit mass of the anode active material layer. In the above range, the pore diffusion resistance of the anode may be reduced, and thus the rapid charging life-span properties of the battery may be improved.

In example embodiments, an average pore diameter of the anode active material layer may be in a range from 500 nm to 1000 nm, from 600 nm to 950 nm, from 700 nm to 800 nm, or from 750 nm to 800 nm. The average pore diameter may be measured using a mercury porosimeter. The electrolyte solution may be easily penetrated into the pores having the diameter in the above range, and thus an amount of pores into which the electrolyte solution does not penetrate may be decreased. Thus, the pore diffusion resistance of the anode may be lowered.

The mercury porosimeter is an apparatus for measuring a porosity, a pore amount, a pore diameter, etc., by a measurement of an amount of a mercury intrusion into a pore entrance. Pore properties may be measured based on a contact angle of mercury that may be changed when mercury is in contact with the anode active material layer.

For example, when assuming that the pore is cylindrical, a diameter and a volume of the pore can be measured by an amount of mercury that enters the pore when a mercury drop enters the pore entrance. The diameter of the pore to be measured is inversely proportional to a pore penetration pressure of mercury, and can be calculated using a Washburn equation represented by Equation 1 below.

$$D = \frac{- 4 τ cos θ}{p} \qquad [ Equation l ]$$

In Equation 1, D is a pore diameter (m), p (pascal) is an applied pressure, τ is a surface tension of mercury (N/m), and θ is a contact angle of mercury on a surface of the anode active material layer) (°).

In example embodiments, the pore diffusion resistance (hereinafter, also referred to as a pore resistance) of the anode active material layer may be 8 Ω or less. In some embodiments, the pore diffusion resistance of the anode active material layer may be 7.5 Ω or less, or 7 Ω or less. In some embodiments, the pore diffusion resistance of the anode active material layer may be 3 Ω or more, 4 Ω or more, or 5 Ω or more.

The term “pore resistance” refers to a resistance required for the electrolyte solution to propagate into the anode active material layer. As the pore resistance becomes greater, a resistance that prevents lithium ions in the electrolyte solution from being transferred from an anode to the current collector to deteriorate a power performance of the battery.

The pore resistance can be measured using an electrochemical impedance spectroscopy (EIS).

An impedance measurement data for each frequency measured by the impedance spectroscopy may be substituted into an impedance equation expressed by Equations 2 and 3 below to calculate the pore resistance.

$${Z}_{faradaic} = \sqrt{\frac{{R}_{ion , L} \cdot {R}_{ct , A}}{( 1 + j ω {R}_{ct , A} \cdot {C}_{dl , A} ) \cdot 2 π r}} coth \sqrt{\frac{{R}_{ion , L} \cdot ( 1 + j ω {R}_{ct , A} \cdot {C}_{dl , A} ) \cdot 2 π r}{{R}_{ct , A}}} L \qquad [ Equation 2 ]$$

Equation 2 is derived using a Transmission Line Model (TLM) theory and is derived from an impedance theory for cylindrical pores which is a resistance theory assuming that all pores have cylindrical shapes.

A j part in Equation 2 is an imaginary number. A ω value is set to 0 to remove the j part, and Equation 3 below can be obtained.

$${Z}_{faradaic , ω \to 0}^{′} = \frac{{R}_{ion}}{3} + {R}_{ct} \qquad [ Equation 3 ]$$

In Equation 3, Z′_{faradaic,ω→o} is a total resistance value, Rᵢₒₙ is a pore resistance value, and R_{ct} is a charge transfer resistance value.

When a coin cell formed of a symmetrical cell with the anode applied equally to a working electrode and a counter electrode is used, no electron movement occurs and the Rct value becomes 0. Thus, a value 3 times the resistance value Z′_{faradaic,ω→o} can be derived as the pre resistance (Rᵢₒₙ) value.

The pore resistance may vary depending on inherent properties of the active material, but may also vary depending on a density of the active material layer. As the pore resistance decreases, the diffusion rate of lithium ions increases and improved electrochemical properties may be provided.

The pore resistance may be measured before a formation treatment. The formation treatment refers to a process that stabilizes a battery structure and modifies the anode for a secondary battery into a usable state. For example, the formation treatment may include a battery pre-charging process, a degassing process, a full charge/discharge process, an aging process, a charging process, etc.

A lithium secondary battery according to embodiments of the present disclosure includes the anode for a secondary battery, and may have a reduced cell resistance and improved rapid charging and life-span properties.

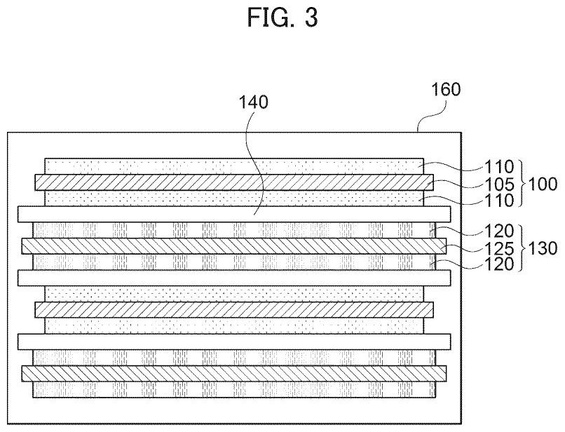

FIG. 2 is a schematic plan-projection view illustrating a lithium secondary battery in accordance with example embodiments. FIG. 3 is a schematic cross-sectional view illustrating a lithium secondary battery in accordance with example embodiments. For example, FIG. 3 is a cross-sectional view taken along a line I-I′ of FIG. 2 in a thickness direction.

Referring to FIGS. 2 and 3, the lithium secondary battery may include an anode 130 according to the above-described embodiments and a cathode 100 facing the anode 130.

The cathode 100 may include a cathode current collector 105 and a cathode active material layer 110 on the cathode current collector 105.

For example, the cathode active material layer 110 includes a cathode active material, and may further include a cathode binder and a conductive material.

For example, a cathode active material, a cathode binder, a conductive material, a dispersion medium, etc., may be mixed and stirred to prepare a cathode slurry. The cathode slurry may be coated on the cathode current collector 105, and then dried and pressed to form the cathode 100.

For example, the cathode current collector 105 may include stainless steel, nickel, aluminum, titanium, copper, or an alloy thereof.

For example, the cathode active material may include a lithium metal oxide particle capable of implementing reversible insertion and desorption of lithium ions.

In an embodiment, the lithium metal oxide particle may contain nickel, cobalt, manganese, aluminum, etc.

In some embodiments, the lithium metal oxide particle may contain nickel, and a content of nickel in the lithium metal oxide particle may be 80 mol % or more of all elements excluding lithium and oxygen.

In some embodiments, the lithium metal oxide particle may include a layered structure represented by Chemical Formula.

[Chemical Formula]

LiₓNi_{(1-a-b)}CoₐM_{b}O_{y}

In Chemical Formula, M may include at least one of Al, Zr, Ti, Cr, B, Mg, Mn, Ba, Si, Y, W and Sr, 0.9≤x≤1.2, 1.9≤y≤2.1, 0≤a+b≤0.5.

In some embodiments, in Chemical Formula, 0<a+b≤0.4, 0<a+b≤0.3, 0<a+b≤0.2, or 0<a+b≤0.1.

The cathode binder and the conductive material may include materials substantially the same as or similar to the anode binder and the conductive material for the abode as described above. For example, the cathode binder may include an organic binder such as polyvinylidene fluoride (PVDF). The cathode binder may be used together with a thickener such as, e.g., carboxymethyl cellulose (CMC).

In some embodiments, an area of the anode 130 may be larger than an area of the cathode 100. In this case, lithium ions generated from the cathode 100 may be easily transferred to the anode 130 without being precipitated.

According to exemplary embodiments, the lithium secondary battery may include a separator 140 and an electrolyte solution interposed between the anode and the cathode.

For example, the separator 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, etc. The separator 140 may also include a non-woven fabric formed from a glass fiber with a high melting point, a polyethylene terephthalate fiber, etc.

In example embodiments, an electrode cell may be defined by the cathode 100, the anode 130 and the separator 140, and a plurality of the electrode cells may be stacked to form an electrode assembly 100. For example, the electrode assembly 150 may be formed by winding, stacking or z-folding of the separator 140.

A non-aqueous electrolyte solution may be used as the electrolyte solution. The non-aqueous electrolyte solution may contain a lithium salt as an electrolyte and an organic solvent. The lithium salt may be expressed as, e.g., Li⁺X⁻. Examples of an anion X⁻ of the lithium salt may include F⁻, Cl⁻, Br⁻, I⁻, NO₃³¹ , N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

Examples of the organic solvent include propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethylsulfoxide, acetonitrile, dimethoxyethane, diethoxyethane, vinylene carbonate, sulfolane, gamma-butyrolactone, propylene sulfite, tetrahydrofuran, etc. These may be used alone or in combination of two or more therefrom.

For example, the electrode assembly 100 and the electrolyte solution may be accommodated together in a case 160 to form a lithium secondary battery.

The lithium secondary battery may be manufactured in, e.g., a cylindrical shape, a prismatic shape, a pouch shape, or a coin shape.

The lithium secondary battery may include electrode leads 107 and 127 being connected to the electrodes 100 and 130 and protruding to the outside of the case 160.

The electrode leads 107 and 127 may include a cathode lead 107 being connected to the cathode 100 and protruding to the outside of the case 160, and an anode electrode lead 127 being connected to the anode 130 and protruding to the outside of the case 160.

For example, the cathode lead 107 may be electrically connected to the cathode current collector 105. The anode lead 127 may be electrically connected to the anode current collector 125.

Each of the cathode current collector 105 of the cathode 100 and the anode current collector 125 of the anode 130 may include a notched portion. The notched portion may serve as, e.g., an electrode tab 116. The notched portion may include a cathode notched portion protruding from the cathode current collector 105 and an anode notched portion protruding from the anode current collector 125.

For example, the cathode current collector 105 may include a protrusion (a cathode tab) at one side thereof. The cathode active material layer 110 may not be formed on the cathode tab. The cathode tab may be integrally formed with the cathode current collector 105 or may be connected by welding. The cathode current collector 105 and the cathode lead 107 may be electrically connected through the cathode tab.

The anode current collector 125 may include a protrusion (an anode tab) at one side thereof. The anode active material layer 120 may not be formed on the anode tab. The anode tab may be integrally formed with the anode current collector 125 or may be connected by welding. The anode current collector 125 and the anode lead 127 may be electrically connected through the anode tab.

The electrode assembly 150 may include a plurality of the cathodes and a plurality of the anodes. For example, a plurality of the cathodes and a plurality of the anodes may be alternately stacked, and the separator may be interposed between the cathode and the anode.

Accordingly, the lithium secondary battery may include the cathode tabs protruding from each of the plurality of the cathodes and the anode tabs protruding from each of the plurality of the anodes.

The cathode tabs (or the anode tabs) may be stacked, pressed, and welded to form a cathode tab stack (or the anode tab stack). The cathode tab stack may be electrically connected to the cathode lead 107. The anode tab stack may be electrically connected to the anode lead 127.

Hereinafter, experimental examples are proposed to more concretely describe embodiments of the present disclosure. However, the following examples are only given for illustrating the present disclosure, and are not to be interpreted as limiting.

### Raw Material 1

Mg-doped SiOx (x<2) particles were prepared.

### Preparation Example 1

The Mg-doped SiOx (x<2) particles (original 1) were treated with an airflow classification device to remove a fine powder. A minimum particle diameter (Dₘᵢₙ) of the Mg-doped SiOx particles from which the fine powder was removed was 2.1 μm.

### Preparation Example 2

Mg-doped SiOx (x<2) particles (Raw Material 1) were treated with an airflow classifier to remove fine powders. A minimum particle diameter (Dₘᵢₙ) of the Mg-doped SiOx particles from which the fine powder was removed was 2.5 μm.

### Raw Material 2

SiOx (x<2) particles were prepared.

Particle sizes of the silicon-based active materials of Raw Materials 1 and 2 and Preparation Examples 1 and 2 were analyzed, and volume-based cumulative particle size distributions were derived using a laser diffraction particle size analyzer (malvern3000). Minimum particle diameter (Dₘᵢₙ), D10, average particle size (D50), D90 and maximum particle diameter (Dₘₐₓ) obtained from the volume-based cumulative particle size distributions are shown in Table 1 below.

TABLE 1

| | Dₘᵢₙ | D10 | D50 | D90 | Dₘₐₓ | D90/ |
|---|---|---|---|---|---|---|
| | (μm) | (μm) | (μm) | (μm) | (μm) | D10 |
| Raw | 0.4 | 3.3 | 6 | 10.1 | 15.7 | 3.06 |
| Material 1 | | | | | | |
| Preparation | 2.1 | 4.1 | 6.3 | 10.2 | 15.5 | 2.48 |
| Example 1 | | | | | | |
| Preparation | 2.5 | 4.3 | 6.5 | 10.3 | 15.4 | 2.39 |
| Example 2 | | | | | | |
| Raw | 0.5 | 3.3 | 5.3 | 8.5 | 14.5 | 2.58 |
| Material 2 | | | | | | |

### Preparation Example 3

The coke was pulverized, and the powder was heat-treated at 3,000° C. for 20 hours to prepare a single particle-type artificial graphite having an average particle diameter (D50) of 8.0 μm.

### Preparation Example 4

The single particle-type artificial graphite (D50: 8.0 μm) prepared in Preparation Example 3 and pitch were mixed in a weight ratio of 90:10, and then heat-treated at 600° C. for 3 to 5 hours. Thereafter, the powder was heat-treated at 3,000° C. to prepare an assembly-type artificial graphite having a secondary particle structure in which single particles were aggregated. An average particle diameter (D50) of the assembly-type artificial graphite was 16 μm.

### Preparation Example 5

100 g of the single particle-type artificial graphite (D50 8.0 μm) prepared in Preparation Example 3 and 20 g of a petroleum pitch (D50 of pitch particles: 2.6 μm, Dₘₐₓ: 15 μm) were added to a mixer (manufactured by Inoue) and stirred at a rate of 20 Hz. After mixing for 30 minutes, a firing was performed at 1,200° C. to prepare an single particle-type artificial graphite including an amorphous carbon (pitch) coating. An average particle diameter (D50) of the amorphous carbon-coated single particle-type artificial graphite was 9.0 μm, and a content of the coating layer (a coating amount) was 1.0 mass % based on a total weight of the amorphous carbon-coated single particle-type artificial graphite.

### Preparation Example 6

A flake-type graphite was put into a continuous grinding classifier to obtain a spherical natural graphite, and then an acid treatment was performed at 80° C. for 12 hours using sulfuric acid/hydrochloric acid/nitric acid, and a spherical natural graphite with a final purity of 99.8% was obtained by washing and drying. D50 of the obtained spherical natural graphite was 10 μm and an average specific surface area was 10 m²/g.

The spherical natural graphite and pitch were mixed in a weight ratio of 95:5, and then coating was performed using a blade mill for 30 minutes, and the mixture was fired at 1,200° C. for 12 hours under a nitrogen atmosphere using a roller hearth kiln (RHK). Subsequently, natural graphite particles were obtained through sorting and de-iron processes.

### Example 1

### (1) Fabrication of Cathode

A first anode active material containing 4.0 wt % of the silicon-based active material of Preparation Example 1 and 96 wt % of a first graphite-based active material, a SWCNT conductive material, and a CMC/SBR binder (1.20/2.40 weight ratio) were included in a weight ratio of 97:2:1 to form a mixture. Water was added to the mixture to form a first anode slurry. The first graphite-based active material included the assembly-type artificial graphite of Preparation Example 4 and the single particle-type artificial graphite of Preparation Example 3 in a weight ratio of 7:3.

A second anode active material including 18.0 wt % of the silicon-based active material of Preparation Example 1 and 82 wt % of a second graphite-based active material, the SWCNT conductive material, and the CMC/SBR binder (1.20/2.40 weight ratio) were included in a weight ratio of 97:2:1 to form a mixture. Water was added to the mixture to form a second anode slurry. The second graphite-based active material included the assembly-type artificial graphite of Preparation Example 4 and the amorphous carbon (pitch)-coated single particle-type artificial graphite of Preparation Example 5 in a weight ratio of 3:7.

The first anode slurry and the second anode slurry were commonly sprayed on one surface of a copper current collector having a thickness of 6 μm to 8 μm while spraying the second anode slurry to be disposed on the first anode slurry. Thereafter, the anode slurry was dried and pressed to form an anode active material layer having a thickness of 97 μm on the copper current collector.

A thickness of an active material layer formed from the first anode slurry was 48.5 μm, and a thickness of an active material layer formed from the second anode slurry was 48.5 μm.

### (2) Fabrication of Lithium Secondary Battery

Li[Ni_{0.88}Co_{0.1}Mn_{0.02}]O₂ as a cathode active material, MWCNT as a conductive material and polyvinylidene fluoride (PVDF) as a binder were mixed in a weight ratio of 98.08:0.72:1.2 to prepare a cathode slurry. The slurry was uniformly coated on an aluminum foil having a thickness of 12 μm, and vacuum-dried to prepare a cathode for a secondary battery. The conductive material included a CNT dispersant in about 20 wt % of a MWCNT.

The cathode and the anode were notched to a predetermined size, and stacked with a separator (polyethylene, thickness: 13 μm) interposed therebetween to form an electrode cell and then tab portions of the cathode and the anode were welded. The welded cathode/separator/anode assembly was put in a pouch, and three sides were sealed except for an electrolyte injection side. A region around the tan portions was included in the sealing portion.

An electrolyte solution was injected into the electrolyte injection side, and then the electrolyte injection side was sealed and an impregnation proceeded for 12 hours or more.

In a preparation of the electrolyte solution, 8 wt % of fluoroethylene carbonate (FEC), 0.5 wt % of 1,3-propensultone (PRS) and 1.0 wt % of 1,3-propansultone (PS) were added after preparing a 1.1M LiPF6 in a mixed solvent of EC/EMC (25/75; volume ratio).

### Example 2

An anode and a lithium secondary battery were fabricated by the same method as that in Example 1, except that the first anode slurry and the second anode slurry were prepared using the silicon-based active material of Preparation Example 2 instead of the silicon-based active material of Preparation Example 1.

### Example 3

An anode and a lithium secondary battery were fabricated by the same

method as that in Example 1, except that a first anode active material including 2.0 wt % of the silicon-based active material of Preparation Example 2 and 98 wt % of the first graphite-based active material was used in the preparation of the first anode slurry, and a second anode active material including 20.0 wt % of the silicon-based active material of Preparation Example 2 and 80.0 wt % of the second graphite-based active material was used in the preparation of the second anode slurry.

### Example 4

An anode and a lithium secondary battery were fabricated by the same method as that in Example 2, except that the second graphite-based active material included the assembly-type artificial graphite of Preparation Example 4 and the amorphous carbon-coated single particle-type artificial graphite of Preparation Example 5 in a weight ratio of 2:8.

### Comparative Example 1

An anode and a lithium secondary battery were fabricated by the same method as that in Example 1, except that Raw Material 1 was used instead of the silicon-based active material of Preparation Example 1.

### Comparative Example 2

An anode and a lithium secondary battery were fabricated by the same method as that in Example 1, except that Raw Material 2 was used instead of the silicon-based active material of Preparation Example 1.

### Comparative Example 3

An anode and a lithium secondary battery were fabricated by the same method as that Example 2, except that the natural graphite of Preparation Example 6 was used instead of each of the first graphite-based active material and the second graphite-based active material.

### Comparative Example 4

An anode and a lithium secondary battery were fabricated by the same method as that Example 2, except that a first anode active material containing 18 wt % of the silicon-based active material of Preparation Example 2 and 82 wt % of the first graphite-based active material was used in the preparation of the first anode slurry, and a second anode active material containing 4 wt % of the silicon-based active material of Preparation Example 2 and 96 wt % of the second graphite-based active material was used in the preparation of the second anode slurry.

### Comparative Example 5

An anode active material including 11.0 wt % of the silicon-based active material of Preparation Example 2 and 89.0 wt % of the graphite-based active material, an SWCNT conductive material and a CMC/SBR binder (1.20/2.40 weight ratio) was mixed in a weight ratio of 97:2:1. Water was added to the mixture to prepare an anode slurry. The graphite-based active material included the assembly-type artificial graphite of Preparation Example 4 and the amorphous carbon (pitch)-coated single particle-type artificial graphite of Preparation Example 5 in a weight ratio of 3:7.

The anode slurry was sprayed on one surface of a copper current collector having a thickness of 6 μm to 8 μm. Thereafter, the anode slurry was dried and pressed to form an anode active material layer having a thickness of 97 μm on the copper current collector.

A lithium secondary battery was manufactured by the same method as that in Example 1, except that the anode was fabricated as described above.

In the anodes of Examples 1 to 4 and Comparative Examples 1 to 5, compositions of the anode active material of the slurry applied to a region adjacent to the anode current collector (a lower portion) and the anode active material of the slurry applied to be spaced apart from the anode current collector are shown in Table 2 below.

TABLE 2

| | lower anode | | upper anode | |
|---|---|---|---|---|
| | active material | | active material | |
| | silicon- | first | silicon- | second |
| | based | graphite- | based | graphite- |
| | anode | based | anode | based |
| | active | active | active | active |
| | material | material | material | material |
| | (content) | (content) | (content) | (content) |
| Example 1 | Preparation | A1:A2 = 3:7 | Preparation | A3:A2 = 7:3 |
| | Example 1 | (96 wt %) | Example 1 | (82 wt %) |
| | (4 wt %) | | (18 wt %) | |
| Example 2 | Preparation | A1:A2 = 3:7 | Preparation | A3:A2 = 7:3 |
| | Example 2 | (96 wt %) | Example 2 | (82 wt %) |
| | (4 wt %) | | (18 wt %) | |
| Example 3 | Preparation | A1:A2 = 3:7 | Preparation | A3:A2 = 7:3 |
| | Example 2 | (98 wt %) | Example 2 | (80 wt %) |
| | (2 wt %) | | (20 wt %) | |
| Example 4 | Preparation | A1:A2 = 3:7 | Preparation | A3:A2 = 8:2 |
| | Example 2 | (96 wt %) | Example 4 | (82 wt %) |
| | (4 wt %) | | (18 wt %) | |
| Comparative | Raw | A1:A2 = 3:7 | Raw | A3:A2 = 7:3 |
| Example 1 | Material 1 | (96 wt %) | Material 1 | (82 wt %) |
| | (4 wt %) | | (18 wt %) | |
| Comparative | Raw | A1:A2 = 3:7 | Raw | A3:A2 = 7:3 |
| Example 2 | Material 2 | (96 wt %) | Material 2 | (82 wt %) |
| | (4 wt %) | | (18 wt %) | |
| Comparative | Preparation | B | Preparation | B |
| Example 3 | Example 1 | (96 wt %) | Example 1 | (82 wt %) |
| | (4 wt %) | | (18 wt %) | |
| Comparative | Preparation | A1:A2 = 3:7 | Preparation | A3:A2 = 7:3 |
| Example 4 | Example 2 | (82 wt %) | Example 2 | (96 wt %) |
| | (18 wt %) | | (4 wt %) | |
| Comparative | Preparation | A3:A2 = 7:3 | — | — |
| Example 5 | Example 2 | (89 wt %) | | |
| | (11 wt %) | | | |

In Table 2, A1 is the single particle-type artificial graphite of Preparation Example 3, A2 is the assembly-type artificial graphite of Preparation Example 4, A3 is the amorphous carbon-coated single particle-type artificial graphite of Preparation Example 5, and B is the natural graphite of Preparation Example 6.

### Experimental Example

Properties of the anodes or the lithium secondary batteries of Examples and Comparative Examples were evaluated according to the following Experimental Examples, and the measured values are shown in Table 3.

### Experimental Example 1: Evaluation on Pore Diffusion Resistance

The anodes of Examples and Comparative Examples were applied commonly as a working electrode and a counter electrode, and an electrode assembly was prepared by interposing a polyethylene separator between the working electrode and the counter electrode. A 1M LiPF₆ solution using a mixed solvent of ethylene carbonate (EC) and diethylene carbonate (EMC) in a volume ratio of 1:4 was injected as an electrolyte solution into the electrode assembly to prepare a symmetric cell. An impedance of the symmetric cell was measures using an electrochemical impedance analysis apparatus in a frequency range of 10⁶ Hz to 0.05 Hz, and an electrolyte resistance and a pore resistance were separated according to Equations 2 and 3 described above to measure the pore resistance.

### Experimental Example 2: Evaluation on Rapid Charge Life-Span Property

Each battery of Examples and Comparative Examples was charged to an SOC (State-of-Charge) 10% with a current of 0.33 C, a stepwise rapid-charged for 15 minutes from 3.5 C to 0.75 C in a section of SOC 10% to 80% and then discharged (0.33 C, SOC 10%, CC cut-off). The above cycle was repeated 200 times, and then a discharge capacity retention was measured as a percentage.

### Experimental Example 3: Measurement of Pore Volume and Average Pore Diameter

For each anode of Examples and Comparative Examples, an amount of pores and an average pore diameter of the anode active material layer were measured using a mercury porosimeter. The instrument used for the measurement was Mercury Porosimetry (Micromeritics USA, AutoPore VI 9500).

TABLE 1

| | | rapid charge/ | | |
|---|---|---|---|---|
| | | discharge | | |
| | pore | capacity | | |
| | diffusion | retention | porosity | average pore |
| | resistance | (200 cyc, %) | (ml/g) | diameter(nm) |
| Example 1 | 6.88 | 83.4 | 0.172 | 765 |
| Example 2 | 6.76 | 86.2 | 0.181 | 789 |
| Example 3 | 6.54 | 89.8% | 0.189 | 780 |
| Example 4 | 6.56 | 86.8% | 0.185 | 775 |
| Comparative | 8.09 | 77.3 | 0.164 | 763 |
| Example 1 | | | | |
| Comparative | 8.15 | 62.8% | 0.160 | 750 |
| Example 2 | | | | |
| Comparative | 18.8 | 40.9% | 0.12 | 461 |
| Example 3 | | | | |
| Comparative | 15.5 | 51.47% | 0.14 | 578 |
| Example 4 | | | | |
| Comparative | 13.8 | 56.88% | 0.16 | 580 |
| Example 5 | | | | |

Referring to Table 3, the anodes of Examples had relatively large porosities amount and pore diameters, and the electrolyte solution was easily impregnated into the pores in the anode, thereby lowering the pore diffusion resistance. Additionally, the content of the silicon-based active material content in the first region was lower than that in the second region, and the capacity was maintained even when the charging and discharging of the battery was repeated.

The anode of Comparative Example 1 included the silicon-based active material having the minimum particle diameter of less than 1 μm. Accordingly, voids between particles were filled and the pore amount was reduced. Further, the pore diffusion resistance was increased and the capacity was decreased during the repeated rapid charging and discharging.

The anode of Comparative Example 2 included the silicon-based active material having the minimum particle diameter of less than 1 μm and being devoid of Thus, the pore amount was reduced and the rapid the magnesium doping. charge/discharge life-span properties were further degraded compared to those from Comparative Example 1.

The anode of Comparative Example 3 included natural graphite instead of artificial graphite, and provided explicitly deteriorated battery performance. Natural graphite was more easily compressed than artificial graphite to cause the reduction of the pore diameter and the pore amount in the anode active material layer during the fabrication of the anode.

In the anode of Comparative Example 4, the silicon-based active material content of the first region adjacent to the electrode current collector was relatively high, and thus the stability of the electrode was explicitly y degraded and the rapid charge/discharge life-span properties of the battery were degraded.

The anode of Comparative Example 5 included the anode active material layer formed of a single anode slurry composition without a differentiation of the first region and the second region, and the stability of the anode and the rapid charge/discharge life-span properties of the battery were degraded.

What is claimed is:

1. An anode for a lithium secondary battery, comprising:
an anode current collector; and
an anode active material layer formed on at least one surface of the anode current collector, the anode active material layer comprising a first region adjacent to the anode current collector and a second region spaced apart from the anode current collector in a thickness direction with the first region interposed therebetween,
wherein the anode active material layer includes an anode active material including an artificial graphite-based active material and a silicon-based active material having a minimum particle diameter (Dₘᵢₙ) in a range from 1 μm to 5 μm, and
a content of the silicon-based active material based on a total weight of the anode active material included in the second region is greater than a content of the silicon-based active material based on a total weight of the anode active material included in the first region.

2. The anode for a secondary battery according to claim 1, wherein the silicon-based active material has the minimum particle diameter (Dₘᵢₙ) in a range from 2 μm to 4 μm.

3. The anode for a secondary battery according to claim 1, wherein the silicon-based active material includes a silicon-based oxide containing at least one doping element selected from Mg, Li, N, B, P, Al, Cu, Mn, Ca and Zn.

4. The anode for a secondary battery according to claim 1, wherein a volumetric average particle diameter (D50) of the silicon-based active material is greater than 6 μm, and less than or equal to 10 μm.

5. The anode for a secondary battery according to claim 1, wherein a ratio D90/D10 is in a range from 1.5 to 2.5,
wherein D10 corresponds 10% in a cumulative particle size distribution based on a volume of the silicon-based active material, and D90 corresponds to 90% in the cumulative particle size distribution based on the volume of the silicon-based active material.

6. The anode for a secondary battery according to claim 1, wherein the content of the silicon-based active material based on the total weight of the anode active material included in the first region is 1 wt % or more, and less than 10 wt %, and
the content of the silicon-based active material based on the total weight of the anode active material included in the second region is in a range from 10 wt % to 25 wt %.

7. The anode for a secondary battery according to claim 1, wherein the artificial graphite-based active material includes a first graphite having a single particle structure and a second graphite having a secondary particle structure.

8. The anode for a secondary battery according to claim 7, wherein a content of the first graphite based on the total weight of the anode active material included in the second region is greater than a content of the first graphite based on the total weight of the anode active material included in the first region, and
a content of the second graphite based on the total weight of the anode active material included in the second region is smaller than a content of the second graphite based on the total weight of the anode active material included in the first region.

9. The anode for a secondary battery according to claim 7, wherein the first graphite includes a graphite of the single particle structure including an amorphous carbon coating on a particle surface.

10. The anode for a secondary battery according to claim 1, wherein a thickness of the first region is in a range from 30% to 70% of a total thickness of the anode active material layer, and a thickness of the second region is in a range from 30% to 70% of the total thickness of the anode active material layer.

11. The anode for a secondary battery according to claim 1, wherein an interface region exists between the first region and the second region, and
a content of the silicon-based active material based on a total weight of the anode active material included in the interface region is equal to or greater than the content of the silicon-based active material based on the total weight of the anode active material included in the first region, and is equal to or less than the content of the silicon-based active material based on the total weight of the anode active material included in the second region.

12. The anode for a secondary battery according to claim 1, wherein the anode active material layer includes pores, and a pore amount in the anode active material layer measured using a mercury porosimeter is in a range from 0.165 ml/g to 0.25 ml/g.

13. The anode for a secondary battery according to claim 1, wherein the anode active material layer includes pores, and an average pore diameter of the anode active material layer measured using a mercury porosimeter is in a range from 500 nm to 1,000 nm.

14. The anode for a secondary battery according to claim 1, wherein the anode active material layer includes pores, and the anode active material layer has a pore diffusion resistance of 8 Ω or less.

15. A lithium secondary battery, comprising:
the anode for a secondary battery of claim 1;
a cathode facing the anode; and
an electrolyte solution.
